(19) United States
(12) Patent Application Publication
(10) Pub. No.: US 2025/0042252 A1
(43) Pub. Date: Feb. 6, 2025

(54) DISPLAY UNIT IN A VEHICLE

(71) Applicant: Continental Automotive Technologies GmbH, Hannover (DE)

(72) Inventors: Jan Hermes, Frankfurt am Main (DE); Ulrich Kabatek, Babenhausen (DE); Kai Hohmann, Babenhausen (DE)

(73) Assignee: Continental Automotive Technologies GmbH, Hannover (DE)

(21) Appl. No.: 18/709,294

(22) PCT Filed: Nov. 3, 2022
(86) PCT No.: PCT/DE2022/200257

§ 371 Date: May 10, 2024

(30) Foreign Application Priority Data
Nov. 25, 2021 (DE) 10 2021 213 256.1

(51) Int. Cl. B60K 35/22; B60K 35/50; B60K 37/20

(52) U.S. Cl. CPC B60K 35/22; B60K 35/50; B60K 37/20; B60K 2360/1523; B60K 2360/339; B60K 2360/349; B60K 2360/48

(57) ABSTRACT

A display unit, arranged in a vehicle interior with a surface is disclosed. A screen, integrated into the surface, with a controllable screen luminance for setting an original screen luminance, a transparent cover element with a cover element surface, is arranged in the viewing direction in front of the screen, and by which the screen is at least partially covered. The cover element surface simulates the surface at least in the viewing direction, and a control unit at least for controlling the screen luminance, wherein the control unit ascertains a correction term in dependence on a material of the cover element surface and/or on a luminance with respect to the cover element which corresponds to the ambient radiation incident on the cover element, and to set the screen luminance based on the correction term such that the original screen luminance is restored from a point of view of an observer.

### CROSS REFERENCE TO RELATED APPLICATIONS

This US patent application claims the benefit of PCT patent application No. PCT/DE2022/200257, filed Nov. 3, 2022, which claims the benefit of German patent application No. 10 2021 213 256.1, filed Nov. 25, 2021, both of which are hereby incorporated by reference.

### TECHNICAL FIELD

The disclosure relates to a display unit arranged in a vehicle interior with a surface, comprising a screen, integrated into the surface, with a controllable screen luminance for setting an original screen luminance, and a transparent cover element with a cover element surface, which is two-dimensionally arranged in the viewing direction in front of the screen and by means of which the screen is at least partially covered, wherein the cover element surface is designed such that it simulates the surface at least in the viewing direction, and a control unit at least for controlling the screen luminance.

### BACKGROUND

A current trend in the automotive sector is the use of screens that are integrated into surfaces and imitate the appearance of the surface. These may be referred to as ShyTech screens. Compared with conventional screens, ShyTech screens try to mimic the surface of typical interior materials, such as wood or aluminum. This creates overall a more harmonious and less busy atmosphere in the interior.

To imitate a specific surface, the screen is equipped with a special transparent cover element. The latter may even be haptically similar to the material in question. Contents are presented through the cover element. ShyTech screens are thus a kind of smart surface, where contents are presented through the surface as needed.

### SUMMARY

It is an object of the disclosure to provide an improved display unit, wherein the display unit comprises a screen of this type which is integrated into a surface of an interior of a vehicle and has a corresponding cover element.

The object is achieved by a display unit having the features as claimed in the claims. The dependent claims list further measures that may be combined with one another as desired in order to achieve further advantages.

The object is achieved by a display unit arranged in a vehicle interior with a surface, comprising a screen, integrated into the surface, with a controllable screen luminance for setting an original screen luminance, and a transparent cover element with a cover element surface, which is two-dimensionally arranged in the viewing direction in front of the screen and by which the screen is at least partially covered, wherein the cover element surface is designed such that it simulates the surface at least in the viewing direction, and a control unit at least for controlling the screen luminance, wherein the control unit is designed to ascertain a correction term in dependence on a material of the cover element surface and/or an incident luminance with respect to the cover element and to set the screen luminance based on the correction term so that the original screen luminance is restored from the viewpoint of an observer.

The term screen may comprise any display here which may bring about a display of at least one symbol, etc., such as displays, monitors etc. The screen may have different pixels to be controlled for display with the primary colors red, yellow, blue, which are each controlled with different luminance.

Transparent cover element may be understood to mean that the cover element is largely or completely see-through, at least in such a way that the display on the screen is recognizable for an observer through the cover element.

Original screen luminance may be understood to mean the screen luminance that is present, from the viewpoint of the observer, without ambient radiation or ambient lighting/incident radiation and without a cover element.

According to the disclosure, it was found that displays on the screen intended for an observer in the vehicle through the cover element look different depending on the ambient radiation, which may also be referred to as ambient lighting. In particular, it was found that for such a screen with a cover element, the ambient radiation may also change the impression of the surface material to be imitated.

According to the disclosure, it was further found that the reason for this is that the light or the perceived luminance reflected by a specific point or pixel to an observer does not depend only on the emitted luminance of the screen. The ambient radiation is additionally incident as luminance on the point from all directions, and a part thereof, in correspondence with the surface material, is reflected in the direction of the observer. Under certain circumstances, such as a very red sunset, this may change the perception of the surface and the display on the screen. This is now prevented with the aid of the disclosure.

According to the disclosure, the control unit is designed to ascertain a correction term in dependence on a material of the cover element surface and/or an incident luminance with respect to the cover element and to set the screen luminance based on the correction term so that the original screen luminance is restored from the viewpoint of an observer. The control unit may, for example, control the individual pixels in such a way that the final pixel color takes into account the reflection properties of the cover element and the ambient radiation incident on the cover element, thus producing the original pixel color, i.e. the pixel color which would occur without the cover element and ambient radiation.

Furthermore, the correction term may be determined in dependence on the cover element surface, for example its reflection properties.

This compensates for the changed perception under unfavorable ambient radiation. The invention allows color correction for integrated screens with a cover element to bring about an adjustment due to ambient radiation.

In a further embodiment, means are provided which measure a luminance as incident ambient radiation with respect to the cover element, wherein the luminance corresponds to the ambient radiation incident on the cover element.

In a further embodiment, the means comprise at least one interior camera to approximate the ambient radiation as incident ambient radiation, wherein the interior camera is arranged within the vehicle. The image generated by the interior camera may be used to approximate the ambient radiation. Depending on the desired accuracy, the image values may be averaged or converted to a low-resolution irradiance map. The latter may indicate an angle-dependent value of the ambient radiation.

In a further embodiment, the means comprises at least one fisheye camera (fisheye, fisheye lens) to determine the luminance of the ambient radiation incident on the cover element surface, wherein the fisheye camera is arranged in the region of the screen in the vehicle. Fisheye (hemispherical camera) is the term used in photography to describe objective lenses that image a hemisphere of an image plane. Such a fisheye camera may capture the angle-dependent luminance values directly with the angle of incidence across the hemisphere.

In addition, the means may also comprise a dedicated camera other than the fisheye camera.

Furthermore, the means comprises at least one incident-light sensor to determine the luminance of the ambient radiation incident on the cover element surface, wherein the at least one incident-light sensor is arranged in the cover element or between the cover element and the screen. By an incident-light sensor under the cover element, no sensor or camera is thus visible to the outside for the observer. Further, if the spectral transmission of the cover element or the cover element surface is known, it may be subtracted from the luminance detected by the incident-light sensor in order to determine the exact luminance.

Further, the at least one incident-light sensor may comprise a specific filter adapted to the transmission of the cover element surface to filter out the wavelengths of the cover element. This allows the luminance or ambient radiation to be detected directly and without further calculation steps.

Furthermore, the control unit may be designed to ascertain the correction term at least based on the time of day and a position of the vehicle. In addition or alternatively, it is also possible to use the time of day in combination with the position of the vehicle instead of a camera/sensor. This allows the determination of correction terms that correct the display at sunrise or sunset, for example.

Furthermore, the control unit may be designed to ascertain the correction term at least based on the time of day and a position of the vehicle and weather information.

In addition to the time of day in combination with the position, weather information may also be used to approximate the expected ambient radiation. For example, severe weather (darkened sky) may be included in the calculation of the correction term.

In addition to the time of day, position and weather, infrastructure objects such as webcams may also be included by the control unit in the ascertainment in order to better approximate the expected ambient radiation.

Further, the control unit may be designed to ascertain the correction term at least based on pre-stored reflection values of the cover element surface. This takes account of the fact that the reflected part of the incident radiation depends on the material properties of the surface.

For example, a highly reflective surface, such as a reflective paint, reflects more light depending on the angle than a non-mirrored, more diffuse surface, which diffuses light more evenly in all directions.

The reflection value can be ascertained in advance. Especially for common materials such as wood, aluminum, etc., good analytical material functions exist that may be used in combination with the texture of the cover element surface to determine the reflection value of the incident radiation (incident luminance) at the material of the cover element surface.

The cover element surface may be measured alternatively or additionally with a material scanner. These scanners provide a table of angle-dependent reflection values. In addition, absorption values and scattering properties of the cover element are also implicitly ascertained. For evaluation purposes, the properties for any angle of incidence or reflection may be read, for example.

Further, the control unit may be designed to ascertain the correction term based on at least pre-stored reflection values of the cover element surface in combination with the luminance with respect to the cover element. This results in a particularly accurate correction term.

Furthermore, the cover element may be in the form of a foil.

In a further embodiment, the control unit is designed to ascertain a single correction term for the entire screen. This makes it possible to easily determine the correction term.

Alternatively, the control unit may be designed to ascertain a plurality of correction terms in dependence on the position of an observer in the vehicle. If the correction term is thus assumed to be non-uniform/direction-dependent, the position of the observer therefore plays a role. For example, the position of the observer is determined/approximated in order to calculate the correction term for each pixel/surface point of the cover element surface according to the angle to the observer. Thus, the correction term varies over the surface of the screen, but may also be used against direction-dependent color shifts. Thus, the influence of the ambient radiation can be eliminated by the various correction terms.

### BRIEF DESCRIPTION OF THE DRAWINGS

Further properties and advantages of the present invention will become apparent from the following description with reference to the accompanying figures, in which, schematically:

FIG. 1: shows a display unit;

FIG. 2: shows an observer with perceived luminance and correction term;

FIG. 3: shows a means for determining the luminance; and

FIG. 4: shows a display unit according to the disclosure in operation.

### DETAILED DESCRIPTION

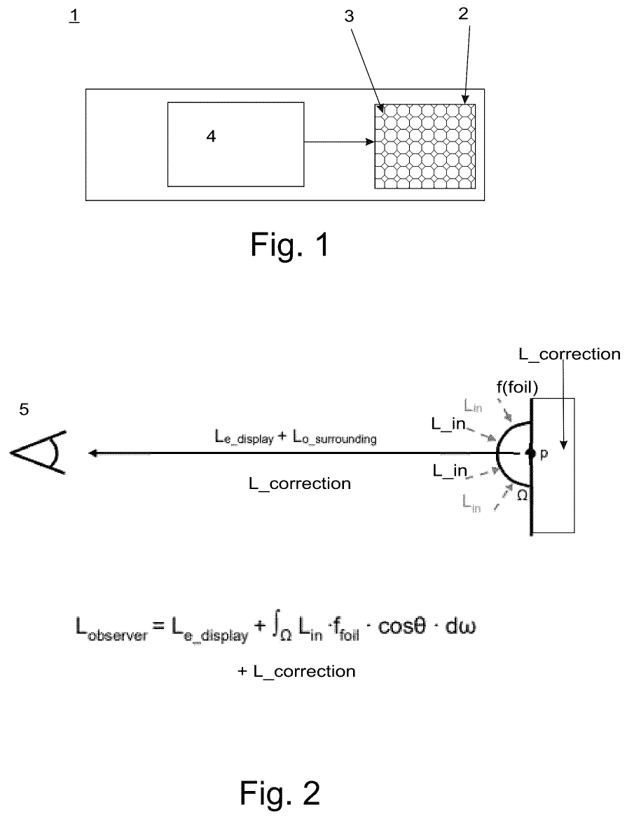

FIG. 1 shows a display unit 1 according to the disclosure, which is arranged in a vehicle (not shown).

The display unit comprises a screen 2, integrated in a surface, for example in a dashboard or in a center console or in a seat, with a controllable screen luminance for setting an original screen luminance L(e_display). To present an image, the different pixels of the screen 2 may be controlled differently.

Further, the display unit 1 has a transparent cover element, which is formed for example as a foil 3 (shown here by way of a pattern) having a foil surface, which is two-dimensionally arranged in the viewing direction in front of the screen 2 and covers the screen 2. The foil surface is designed in such a way that it simulates the surrounding surface at least in the viewing direction. As a result, the screen is virtually completely integrated into the vehicle's interior, such as the seat, center console, etc.

The original screen luminance L(e_display) is changed for an observer 5 by the foil 3 depending on the ambient radiation or on radiation which is incident on the foil 3 and is reflected thereby.

For example, the foil surface may look like wood when the screen 2 is integrated into a center console having a wood-like appearance.

In this way, screens 2 can thus be arranged inconspicuously in a vehicle interior.

Furthermore, a control unit 4 is provided for controlling the screen luminance L(e_display) of the screen 2.

It can be provided or configured in an embedded computer which, for example, sends image content to the screen 2 or screens for presentation via HDMI. For example, the image content may be generated using the programmable 3D units of modern graphics cards (graphics processing unit, GPU). Various APIs (application programming interface) such as OpenGL ES are available for this purpose. The application can use these APIs to calculate an image from geometry and image data as well as various programs via the GPU. One such program is, for example, a pixel shader, which is used for example to calculate the final pixel color, for example the final composition of the primary colors red, green and blue (RGB).

FIG. 2 shows an observer 5 who has a screen 2 with a surface-imitating foil 3.

As in FIG. 2, the observer 5 perceives the luminance L(e_display) differently through the foil 2 than without such a foil.

According to the disclosure, it was found that the color or luminance L(observer) which an observer 5 perceives from a surface point of the screen 2 or through the foil 3 depends on the incident radiation (L(in)) and its angle on the foil 2 (i.e. the ambient radiation), as well as on the reflection properties of the foil 3. The reflection properties depend here on the foil material or on the foil surface condition. For example, a highly reflective surface, such as a reflective paint, reflects more light depending on the angle than a non-mirrored, more diffuse surface, which diffuses light more evenly in all directions.

In accordance with the laws of geometric optics, L(observer) corresponds to the luminance L(e_display) emitted by the surface point, i.e. to the luminance emitted by the screen 2 itself and the total luminance L(in) that is incident on the screen 2 or on the screen pixel P, of which a part here is likewise reflected as L(o_surrounding) in the direction of the observer 5.

This reflected part L(o_surrounding) is dependent on the reflection properties, i.e. the material properties of the surface, and is described by a BRDF (bidirectional material reflectance function) f(foil):

This results in:

$$L ( observer ) = L ( e\_display ) + \int L ( i n ) * f ( foil ) * cos θ d ω$$

$$wherein$$

$$\int L ( in ) * f ( foil ) * cos θ d ω = L ( o\_surrounding )$$

Lo_surrounding can be neglected under ideal conditions. In the case of strong or highly colored ambient radiation and the correspondingly perceived luminance L(in), on the other hand, Lo_surrounding may become large and change the total luminance L(observer) in the direction of the observer 5.

In order to compensate for this altered perception under unfavorable ambient radiation, an additional correction term L(correction) based on L(in) and f(foil) is ascertained by the control unit 4. The correction term L(correction) can be used to set the final pixel color of the screen 2 to change the pixel color such that

$$L ( observer ) + L ( o\_surrounding ) + L ( correction ) \approx Le\_display$$

It follows that

L(o_surrounding)≈−L(correction)

And thus

L(observer)≈(Le_{display})

For this purpose, the reflection properties must be determined based on reflection values in relation to the foil 3. For this purpose, there are good analytical material functions especially for common materials such as wood-like foil 3, aluminum-like foil 3, etc., which may be used in combination with the foil texture to determine f(foil) as analytical material functions.

Alternatively or additionally, the foil 3 or, if appropriate, the material to be imitated may be measured with a material scanner. This scanner provides a table of angle-dependent reflection values of the scanned material, which implicitly contain the absorption values and scattering properties. For evaluation purposes, these properties may be read for any angles of incidence and reflection. Depending on the desired accuracy, the material function can be uniform or non-uniform over the foil surface.

For example, the reflection values obtained in this way may be stored in a database.

The surface material and its reflection properties can be determined during development or production. During runtime, the reflected ambient radiation may then be determined based on the reflection properties and then used as a correction term L(correction) to subtract unwanted light.

For this purpose, the light L(in) incident on the foil 3 must be determined.

Various means may be provided for this purpose.

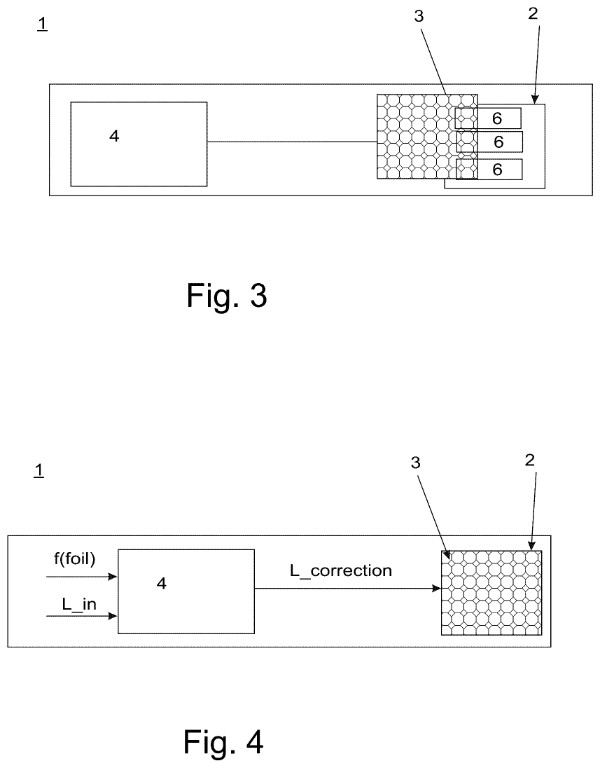

FIG. 3 shows one of these means by way of example.

In this case, incident-light sensors 6 are arranged between the screen 2 and the foil 3. Owing to this arrangement, no sensor or camera is visible to the outside. Since the spectral transmission of the foil surface is known, it may be subtracted from the luminance L(in) detected by the incident-light sensors 6 in order to determine the ambient radiation. The incident-light sensors 6 may also comprise a specific filter adapted to the transmission of the foil surface in order to filter out the wavelengths of the foil 3. As a result, a more accurate luminance L(in) of the foil 3 or the ambient radiation may be detected more accurately.

Alternatively or optionally, for example, fisheye cameras (hemispherical cameras; not shown) may be arranged in the region of the screen 2 to determine the foil luminance of the luminance L(in) incident on the foil surface. These cameras may capture the angle-dependent luminance L(in) directly with the incident angle across the hemisphere.

In addition, interior cameras may also be used. The image generated by such an interior camera may be used to approximate the luminance L(in). Depending on the desired accuracy, the image values may be averaged or converted to a low-resolution irradiance map. The latter then specifies an angle-dependent value of L(in).

FIG. 4 shows a display unit 1 according to the disclosure in operation.

Based on the known reflection values f(foil) in combination with the detected luminance L(in) incident on the screen 2, the correction term L(correction) may now be determined and based thereon the individual pixels of the screen 2 may be corrected.

1. A display unit, which is arranged in a vehicle interior with a surface, comprising
a screen, integrated into the surface, with a controllable screen luminance for setting an original screen luminance;
a transparent cover element with a cover element surface, which is two-dimensionally arranged in the viewing direction in front of the screen
and by which the screen is at least partially covered, wherein the cover element surface is designed such that it simulates the surface at least in the viewing direction; and
a control unit at least for controlling the screen luminance,
wherein
the control unit is further designed to ascertain a correction term in dependence on a material of the cover element surface and/or on a luminance with respect to the cover element which corresponds to the ambient radiation incident on the cover element, and to set the screen luminance based on the correction term in such a way that the original screen luminance is restored from a point of view of an observer.

2. The display unit as claimed in claim 1, wherein means are provided which measure a luminance as incident ambient radiation with respect to the cover element.

3. The display unit as claimed in claim 2, wherein the means comprises at least one interior camera to approximate the ambient radiation as incident ambient radiation, wherein the interior camera is arranged within the vehicle.

4. The display unit as claimed in claim 2, wherein the means comprises at least one fisheye camera (fisheye, fisheye lens) to determine the luminance of the ambient radiation incident on the cover element surface, wherein the fisheye camera is arranged in the region of the screen in the vehicle.

5. The display unit as claimed in claim 2, wherein the means comprises at least one incident-light sensor to determine the luminance of the ambient radiation incident on the cover element surface, wherein the at least one incident-light sensor is arranged in the cover element or between the cover element and the screen.

6. The display unit as claimed in claim 5, wherein the at least one incident-light sensor comprises a specific filter adapted to the transmission of the cover element surface in order to filter out the wavelengths of the cover element.

7. The display unit as claimed in claim 1, wherein the control unit is designed to ascertain the correction term at least based on the time of day and a position of the vehicle.

8. The display unit as claimed in claim 7, wherein the control unit is designed to ascertain the correction term at least based on the time of day and a position of the vehicle and weather information.

9. The display unit as claimed in claim 1, wherein the control unit is designed to ascertain the correction term based on at least pre-stored reflection values of the cover element surface.

10. The display unit as claimed in claim 9, wherein the control unit is designed to ascertain the correction term at least based on pre-stored reflection values of the cover element surface.

11. The display unit as claimed in claim 1, wherein the cover element is in the form of a foil.

12. The display unit as claimed in claim 1, wherein the control unit is designed to ascertain a single correction term for the entire screen.

13. The display unit as claimed in claim 1, wherein the control unit is designed to ascertain a plurality of correction terms in dependence on the position of an observer in the vehicle.
